(19) United States
(12) Patent Application Publication
(10) Pub. No.: US 2021/0288377 A1
(43) Pub. Date: Sep. 16, 2021

(54) BATTERY STOPPER

(71) Applicant: FRÖTEK VERMÖGENSVERWALTUNG GMBH, Osterode am Harz (DE)

(72) Inventor: Thomas KOCH, Northeim (DE)

(21) Appl. No.: 16/348,643

(22) PCT Filed: Jan. 17, 2018
(86) PCT No.: PCT/EP2018/000022

§ 371 Date: May 9, 2019

(30) Foreign Application Priority Data
Mar. 3, 2017 (DE) 10 2017 002 024.8

(51) Int. Cl. H01M 50/308; H01M 50/325

(52) U.S. Cl. CPC H01M 50/308; H01M 50/325

(57) ABSTRACT

The invention relates to a battery stopper of a battery or a battery cell, wherein a degassing valve is arranged in the battery stopper and from a certain pressure level releases gas created in the electrolyte, wherein the stopper interior is divided into two areas by a transverse wall arranged at right angles or at an incline relative to the stopper upper side, a first of said areas being connected only to the cell interior and the second of said areas being connected only to the atmosphere, wherein the transverse wall has at least one passage connecting the two areas, with the degassing valve being arranged in or on said passage.

The invention relates to a battery stopper of a battery or of a battery cell where a degassing valve in the battery stopper and at a certain pressure level releases gas generated in the electrolyte.

Such a battery stopper is known for example from DE 20 2005 003 835 [U.S. Pat. No. 7,951,474]. The battery stopper has a relatively large number of parts due to the presence of the degassing valve and is therefore expensive to manufacture.

The object of the invention is to improve a battery stopper of the above-described type so that it is of simple design and easy to manufacture while being composed of a minimum number of parts.

This object is achieved according to the invention in that the stopper has an interior subdivided into first and second compartments by a transverse partition extending at a right angle or at an incline relative to the stopper upper face, the first compartment opening only into the cell interior and the second compartment opening only into the atmosphere, the transverse partition having at least one passage connecting the two compartments, the degassing valve being in or on the passage. In particular, the body of the battery stopper may be seated within a hole of the upper wall of the battery or battery cell.

Such a battery stopper has a body integrally formed as one piece with the exception of the additional valve member and thus is particularly simple to manufacture, since only the valve member has to be inserted, in particular clipped into the one battery-stopper body. Secure operation is thereby provided.

Preferably, it is proposed that the second compartment is open laterally in order to be closed by an inner wall of the hole of the battery or battery cell housing the battery stopper. In this way, the valve member is particularly easy to install into the stopper body.

It is particularly advantageous if due to the in particular vertical arrangement of the valve closing surface of the degassing valve, entrained electrolyte components are reduced by force of gravity in the direct functional region. For this purpose, the lower region of the second compartment is provided with a receptacle for entrained electrolyte components that are conveyed upward with the gas to be vented.

The valve provided in the battery stopper of particularly simple design and easy to manufacture if the valve member opened by gas pressure of the degassing valve comprises a valve disk made of flexible plastic that covers the passage of the transverse partition. In particular, the valve disk is on a side of the transverse partition delimits the compartment opening into the atmosphere.

A simple assembly and a safe fixing are provided if the valve disk comprises a projection, in particular a pin that fits into a horizontally throughgoing bore of the transverse partition. In particular, the free end of the projection/pin may be provided with a thickened head portion whose diameter is larger than the diameter of the projection/pin.

It is preferably proposed that the valve member is formed with a bore. In particular, the bore extends in the form of a blind bore into the projecting pin. This bore increases the flexibility of the valve member and is useful as an assembly aid.

An embodiment of the invention is illustrated in the drawing and will be described in more detail below. In particular

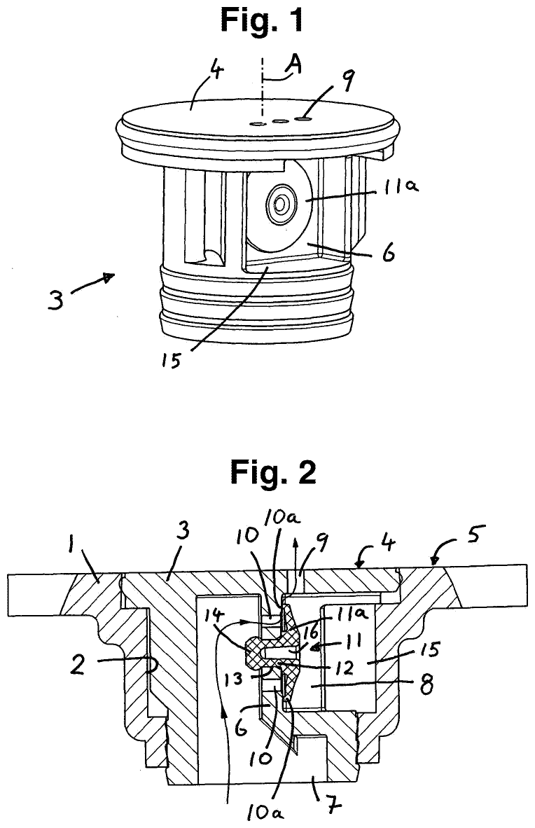

FIG. 1 is a perspective view of the battery stopper, and

FIG. 2 is an axial vertical section through the battery stopper inserted in the battery upper wall.

A battery or a battery cell comprises an upper horizontal upper wall 1 having a vertical hole 2 in which a battery-stopper body 3 is snugly seated. In particular, an upper face 4 of the battery stopper is flush with an upper face 5 of the battery or battery cell. In particular, the battery stopper is, except for the valve member 11b of the degassing valve 11, of one-piece construction.

The interior of the battery stopper 3 is divided by a transverse partition 6 extending orthogonally (or at right angles) or at an incline relative to the stopper upper face into a first compartment 7 and a second compartment 8, the first compartment 7 opening downward into the interior of the battery cell and is axially upwardly closed. The second compartment 8 is axially downwardly closed and opens upward through an upper hole 9 at the upper face 4 so that this second compartment is open to the atmosphere. In particular, the lower region of the second compartment 8 has a receptacle for particles, in particular for aerosols that are conveyed upward with the gas to be vented.

The transverse partition 6 is formed with at least one bore forming a passage 10 through which the two compartments 7 and 8 communicate with each other. In the embodiment of FIG. 2, two such passages 10 are shown in the transverse partition 6.

The passages 10 are covered by a valve disk 11a that rests on the side face of the transverse partition 6 turned into the second compartment 8. The valve disk 11a forms the valve member 11b of the degassing valve 11 that, as an overpressure valve, allows gas generated by the electrolyte to pass from the compartment 7 into the compartment 8 above a certain pressure so that gas passes through the hole 9 and dissipates into the atmosphere.

The degassing valve 11 is made of a flexible plastic integrally formed with the valve disk 11a and on whose rear face a pin 12 is formed that is tightly seated in a hole or bore 13 of the transverse partition 6. The free end of the projecting pin 12 has a thickened head portion 14 that protrudes into the compartment 7 and extends outward past the outer edge of the bore 13. Due to this shape of the pin 12, the valve member is pressed against the face of the partition 6 facing into the compartment 8

The second compartment 8 is open laterally and closed by an inner wall of the hole 2 of the battery or battery cell that houses the battery stopper. The valve member 11 is installed through this opening 15 and fitted to the transverse partition 6.

The valve member 11b has a blind bore 16 open toward the compartment 8 and oppositely extending into the projecting pin 12.

1-11. (canceled)

12. A battery stopper for upwardly closing a battery or battery cell, the stopper comprising:
a one-piece body fittable in an upper wall of the battery or battery cell and having an interior;
a partition unitarily formed in the body and subdividing the interior into a first compartment open downwardly into the battery or battery cell and a second compartment open upwardly outside the battery or battery cell, the partition being formed with a throughgoing passage interconnecting the compartments; and
a one-way pressure-relief valve mounted on the partition over the passage and permitting fluid flow through the passage only when a pressure in the first compartment exceeds a pressure in the second compartment by a predetermined limit.

13. The battery stopper defined in claim 12, wherein the upper wall is formed with a vertically throughgoing hole into which the body is snugly fitted.

14. The battery stopper defined in claim 13, wherein the second compartment has a laterally open side wall opening closed by the upper wall of the battery or battery cell when the body is fitted in the hole thereof.

15. The battery stopper defined in claim 12, wherein the valve includes a valve body in the second compartment and engageable horizontally with the passage to block same, the second compartment forming below the valve body an only upwardly open receptacle into which particles in exiting gas fall after passing through the passage from the first compartment.

16. The battery stopper defined in claim 12, wherein the valve has a flexible-plastic valve disk.

17. The battery stopper defined in claim 16, wherein the flexible valve disk is engageable with a face of the partition turned into the second compartment for closing the passage.

18. The battery stopper defined in claim 17, wherein the partition is formed adjacent the passage with a bore and the valve disk is unitarily formed with a pin engaging in the bore and positioning the valve disk on the face of the partition.

19. The battery stopper defined in claim 18, wherein the bore is throughgoing and the pin is formed with an enlarged head such that when the pin is fitted through the bore the head is in the first compartment and engages a face of the position turned into the first compartment.

20. The battery stopper defined in claim 19, wherein the valve disk is formed with a bore.

21. The battery stopper defined in claim 21, wherein the bore of the valve disk is blind and extends into the pin and facilitates radial compression of the pin.
